(19) United States
(12) Patent Application Publication
(10) Pub. No.: US 2006/0044215 A1
(43) Pub. Date: Mar. 2, 2006

(54) Scalable tiled display assembly for forming a large-area flat-panel display by using modular display tiles

(76) Inventors: Thomas P. Brody, Pittsburgh, PA (US); Paul R. Malmberg, Pittsburgh, PA (US); Joseph A. Marcanio, Latrobe, PA (US)

Correspondence Address: DICKSTEIN SHAPIRO MORIN & OSHINSKY LLP, 2101 L Street, NW, Washington, DC, 20037, US

(21) Appl. No.: 10/923,695

(22) Filed: Aug. 24, 2004

(51) Int. Cl. G09G 5/00

(52) U.S. Cl. 345/1.3

(57) ABSTRACT

A scalable tiled display assembly that includes an array of independently addressed active-matrix organic light-emitting diode (OLED) display tiles cabled to a central control module. Each display tile includes a frame, a driver sub-module, and a flat ribbon cable for connecting the driver sub-module to the display tile. Furthermore, column and row drivers are integrated within each display tile for improved performance and minimal external connections. The invention further includes a method of forming a scalable tiled display system that includes the steps of assembling a plurality of display tile assemblies, determining the viewable area of the display, assembling an array of display tile assemblies according to the desired viewable area, and activating the scalable tiled display system.

### FIELD OF THE INVENTION

The present invention relates to a modular large-screen organic light-emitting diode (OLED) display. In particular, the invention relates to a scalable tiled display assembly for forming a large-area flat-panel display using modular display tiles.

### BACKGROUND OF THE INVENTION

OLED technology incorporates organic luminescent materials that produce intense light of a variety of colors when sandwiched between electrodes and subjected to a DC electric current. These OLED structures can be combined into the picture elements, or pixels, that comprise a display. OLEDs are also useful in a variety of applications as discrete light-emitting devices or as the active element of light-emitting arrays or displays, such as flat-panel displays in watches, telephones, laptop computers, pagers, cellular phones, calculators, and the like. To date, the use of light-emitting arrays or displays has been largely limited to small-screen applications, such as those mentioned above.

Demands for large-screen display applications that possess higher quality and higher light output has led the industry to turn to alternative display technologies that may replace older light-emitting diode (LED) and liquid crystal displays (LCDs). For example, LCDs fail to provide the bright, high light output, larger viewing angles and speed requirements that the large-screen display market demands. By contrast, OLED technology promises bright, vivid colors in high resolution, high speed reaction and at wider viewing angles. However, the use of OLED technology in large-screen display applications, such as outdoor or indoor stadium displays, large marketing advertisement displays, and mass-public informational displays, is only beginning to emerge. Consequently, the market is now demanding larger displays that have the flexibility to customize display sizes.

Modular or tiled displays are made from smaller modules or displays that are then combined into larger displays. These tiled displays are manufactured as a complete unit that can be further combined with other tiles to create displays of any size and shape. Two barriers to implementing the tiled approach have been: 1) eliminating the visibility of the seams between tiles; and 2) providing electrical access to the pixels. No practical tiled display system has yet been developed (video walls formed by abutting conventional cathode ray tube (CRT) displays are not considered tiled because of their wide separations between adjacent displays). Accordingly, there is a need for a scalable modular OLED display that is cost-effective, seamless, and is easy to assemble electrically and mechanically.

An examplary tiled display is described in U.S. Pat. No. 5,644,327, entitled “Tessellated Electroluminescent Display having a Multilayer Ceramic Substrate.” The '327 patent describes an electroluminescent display and a combination field emissive and electroluminescent display which are formed as tiles that may be joined together to provide a large-area display device. The exemplary tiles are formed using low-temperature cofired ceramic and metal structures consisting of multiple layers of ceramic circuit-board material laminated to a metal core. Driving circuitry for the displays is mounted on the back of the structures and vias are passed through the structure from the back to the front in order to make connection with the pixel electrodes on the front of the display device.

Although the tiled display described in the '327 patent provides a means for interconnecting tiles to create a large display system, the '327 patent fails to provide a scalable modular OLED display that is easy to assemble and is low cost.

It is therefore an object of the invention to provide a scalable modular OLED display that is cost-effective, seamless, and is easy to assemble electrically and mechanically.

It is another object of this invention to provide a cost-effective way of forming an arbitrarily large flat-panel display.

It is yet another object of this invention to provide an OLED display module that can be used as a component for easily scaling a flat-panel display to any size.

### BRIEF SUMMARY OF THE INVENTION

The present invention is a scalable tiled display assembly for forming a large-area flat-panel display by using display tiles that are easily assembled in a modular fashion. The scalable tiled display assembly of the present invention is formed of an array of independently addressed display tiles that are assembled in a modular fashion to achieve a seamless large-area flat-panel display of any desired size. Additionally, column and row drivers are integrated within each display tile for improved performance and minimal external connections. Furthermore, the scalable large-area flat-panel display of the present invention is thin, light weight, and low cost.

### BRIEF DESCRIPTION OF THE DRAWINGS

FIG. 1A illustrates a front view of a display tile that has integrated column and row drivers in accordance with the invention;

FIG. 1B illustrates an expanded view of a column driver region of the display tile of the present invention;

FIG. 2 illustrates a perspective view of a display tile assembly in accordance with the invention;

FIG. 3 illustrates a front view of a tiled display that is scalable to any size by assembling an array of display tiles in accordance with the invention;

FIG. 3B is an end view of the tiled display of FIG. 3A;

FIG. 4 illustrates a perspective view of a scalable tiled display system that is scalable to any size by assembling an array of display tile assemblies in accordance with the invention; and

FIG. 5 illustrates a flow diagram of a method of forming a scalable tiled display system in accordance with the invention.

### DETAILED DESCRIPTION OF THE PREFERRED EMBODIMENT

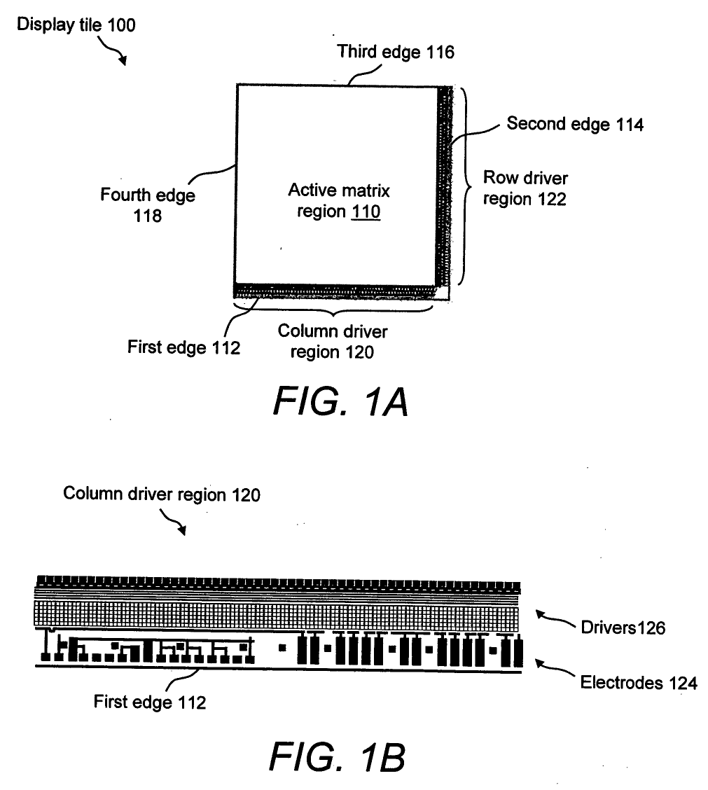

FIG. 1A illustrates a front view of a display tile 100 that has integrated column and row drivers. Display tile 100 is suitable for use in a modular flat-panel display in accordance with the invention. Display tile 100 is a thin (100-150 μm) flexible active matrix OLED display panel that is, for example, 10 to 12 inches square. Display tile 100 includes an active matrix region 110, which includes electronic circuitry for an array of light-emitting devices, such as OLEDs. Display tile 100 is bounded by a first edge 112, a second edge 114, a third edge 116, and a fourth edge 118. Display tile 100 further includes a column driver region 120 along first edge 112 and a row driver region 122 along second edge 114. Column driver region 120 includes integrated column drivers for receiving the display data. Row driver region 122 includes integrated row drivers for receiving the pulsed row signals, as is well known. The design of display tile 100 includes the integrated drivers, which allow for high performance drivers with regard to speed and current capability, as display tile 100 uses cadmium selenide (CdSe) for forming the electronic elements instead of the lower performance amorphous silicon used with LCDs. The integrated row and column drivers of column driver region 120 and row driver region 122 are formed with the same manufacturing process as active matrix region 110.

FIG. 1B illustrates an expanded view of a column driver region 120 that further includes an exemplary arrangement of electrodes 124 along the outer edge of display tile 100 that allow for electrical connections to an associated exemplary arrangement of drivers 126 for driving active matrix region 110. In like manner, row driver region 122 includes an arrangement of electrodes 124 and an arrangement of drivers 126. There is one driver 126 associated with each row and column within active matrix region 110. There is one electrode 124 associated with each driver 126.

With reference to FIGS. 1A and 1B, the placement of column driver region 120 and row driver region 122 (with electrodes 124 and drivers 126) is not limited to two separate edges, respectively. Column driver region 120 and row driver region 122 may both be formed on a single edge only, for example. The width of column driver region 120 and row driver region 122 is any suitable dimension for providing a layout of electrodes 124 and drivers 126 that is practical for making connections to an external cable, for example.

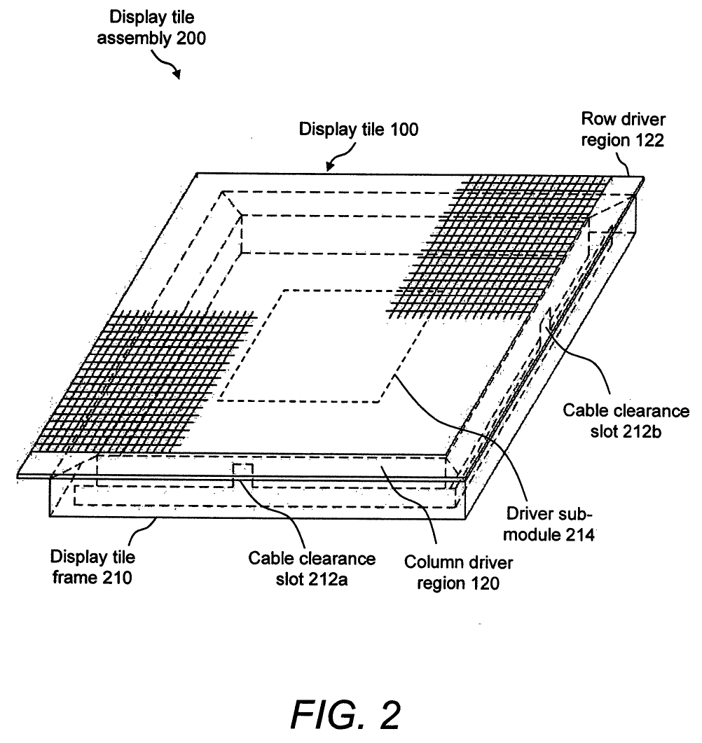

FIG. 2 illustrates a perspective view of a display tile assembly 200 in accordance with the invention. Display tile assembly 200 includes display tile 100 mounted atop a display tile frame 210. Display tile frame 210 further includes multiple cable clearance slots 212 for feeding a cable (not shown) from a driver sub-module 214 to column driver region 120 and row driver region 122 of display tile 100, for example, a cable clearance slot 212a for feeding a cable (not shown) from driver sub-module 214 to column driver region 120 and a cable clearance slot 212b for feeding a cable (not shown) from driver sub-module 214 to row driver region 122. The individual conductors of the cables, such as standard flat ribbon cables, from driver sub-module 214 are electrically connected to electrodes 124 of column driver region 120 and row driver region 122 via soldering or clamping.

Driver sub-module 214 provides a second set of active drivers as a signal distribution mechanism for addressing drivers 126 of column driver region 120 and row driver region 122 and, thus, provides the drive data and picture information to display tile 100. Driver sub-module 214 also provides power and timing signals to its associated tile. Driver sub-module 214 is, for example, a standard printed circuit board with active driver devices. Driver sub-module 214 is located behind display tile 100 and is sized suitably small enough to fit within display tile frame 210. Display tile frame 210 is formed of any suitable lightweight and rigid material, such as molded plastic or aluminum. Display tile frame 210 forms a physical cage of support for display tile 100 at the edges of display tile 100.

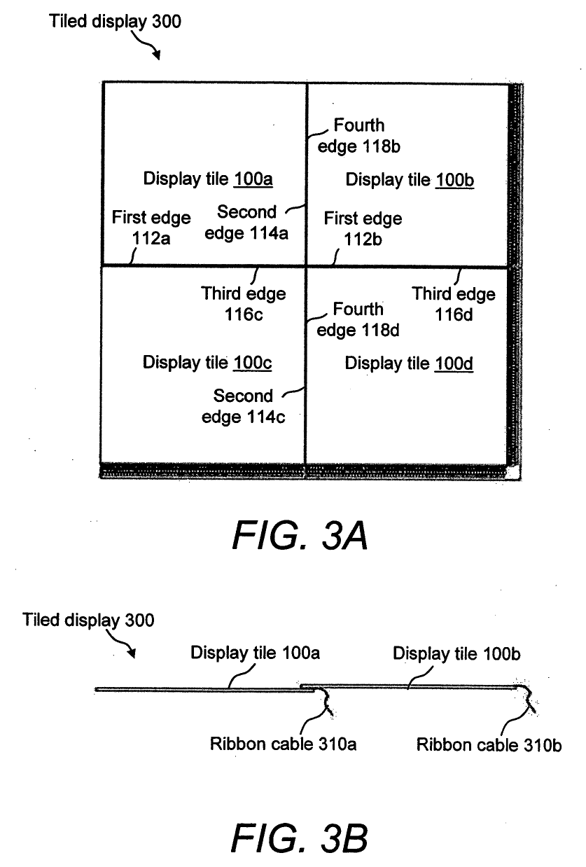

FIG. 3A illustrates a front view of a tiled display 300 that is scalable to any size by assembling an array of display tiles 100 in accordance with the invention. For example, FIG. 3A shows a 2×2 arrangement of a display tile 100a, a display tile 100b, a display tile 100c, and a display tile 100d. Tiled display 300 is not limited to the 2×2 arrangement shown in FIG. 3A. Tiled display 300 is scalable to any arbitrary number of display tiles 100 to form a large-area tiled display 300 of any desired dimension.

In the example of FIG. 3A, fourth edge 118b of display tile 100b overlaps row driver region 122a (not visible) at second edge 114a of display tile 100a, third edge 116c of display tile 100c overlaps column driver region 120a (not visible) at first edge 112a of display tile 100a, third edge 116d of display tile 100d overlaps column driver region 120b (not visible) at first edge 112b of display tile 100b, and fourth edge 118d of display tile 100d overlaps row driver region 122c (not visible) at second edge 114c of display tile 100c. As a result, only active matrix region 110 of each display tile 100 is visible and, thus, tiled display 300 appears as seamless to the viewer thereof.

FIG. 3B is an end view of tiled display 300 of FIG. 3A. In this view, the overlap of fourth edge 118b of display tile 100b upon row driver region 122a (not visible) at second edge 114a of display tile 100a is evident. Additionally, FIG. 3B shows that tiled display 300 includes a plurality of ribbon cables 310. For example, a ribbon cable 310a sandwiched between display tile 100a and display tile 100b that is mechanically and electrically connected to electrodes 124 (not visible) of display tile 100a. Likewise, a ribbon cable 310b is mechanically and electrically connected to electrodes 124 (not visible) of display tile 100b. Each display tile 100 is independently powered and addressed via its own ribbon cable 310. The total thickness of tiled display 300 at the overlap area is in the range of 6 to 10 mils. Alternatively, the ribbon cable electrodes (i.e., electrodes 124) may be replaced by electrodes formed on the edge on the backside of each display tile 100. This would allow ribbon cable 310 to come off the back of display tile 100, rather than be sandwiched between one display tile 100 and the next, thereby reducing the total overlap thickness.

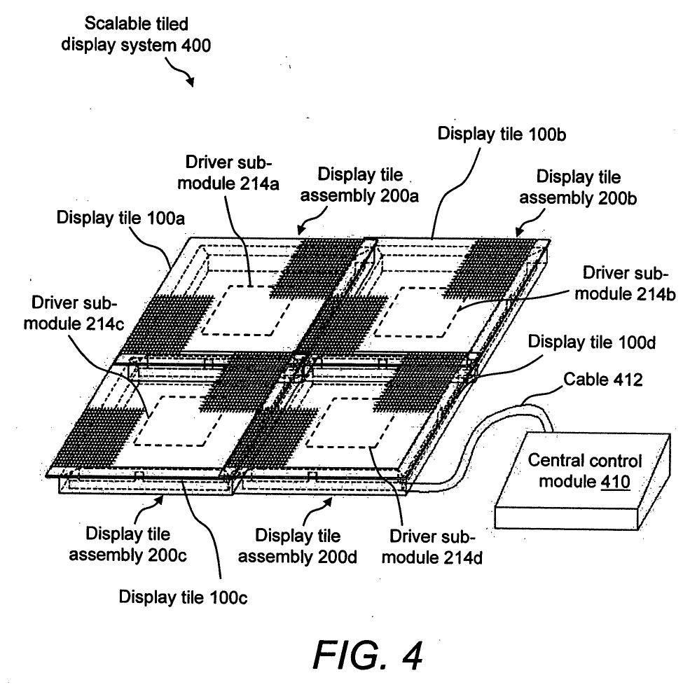

FIG. 4 illustrates a perspective view of a scalable tiled display system 400 that is scalable to any size by assembling an array of display tile assemblies 200 in accordance with the invention. For example, FIG. 4 shows a 2×2 arrangement of a display tile assembly 200a, a display tile assembly 200b, a display tile assembly 200c, and a display tile assembly 200d. Scalable tiled display system 400 further includes a central control module 410 that is electrically connected to the array of display tile assemblies 200 via a cable 412. More specifically, cable 412 is representative of a bundle of cables that connect central control module 410 to/from all driver sub-modules 214 that are present within scalable tiled display system 400. On one end each cable within the bundle represented by cable 412 is electrically connected to its associated driver sub-module 214 via soldering or a standard multi-pin cable connector. Similarly, the opposite end is electrically connected to the electronics of central control module 410 via a standard multi-pin cable connector. Central control module 410 serves as the central image processor. Central control module 410 controls the scanning and illumination of the pixels on each display tile 100.

A second set of ribbon cables 310 (not shown) connects each driver sub-module 214 to electrodes 124 of its respective display tile 100. Cable 412 also handles the power distribution and timing signals to all driver sub-modules 214 and display tiles 100. The structure of scalable tiled display system 400 forms physical cages of support (i.e., display tile frames 210) with the face of the individual display tiles 100 arranged seamlessly along a common visible plane, whereby all substructures and cables are hidden from view.

In operation, central control module 410 addresses each driver sub-module 214 via cable 412 with their respective picture information, i.e., drive data, brightness, and picture information. Central control module 410 serves at the image processor that provides image data that is specific to each display tile 100, based upon the physical location of each given display tile 100 within the overall scalable tiled display system 400 and, thus, each display tile 100 is independently addressed. Central control module 410 controls the scanning and illumination of the pixels on each display tile 100. Each driver sub-module 214 then distributes the signals via ribbon cables 310 to its respective display tile, 100 and, thus, addresses its respective column driver region 120 and row driver region 122. As is well known, row driver elements are excitable one at a time, while column drivers receive the picture data and then store it in local memory, which is then energized by the row gating signals.

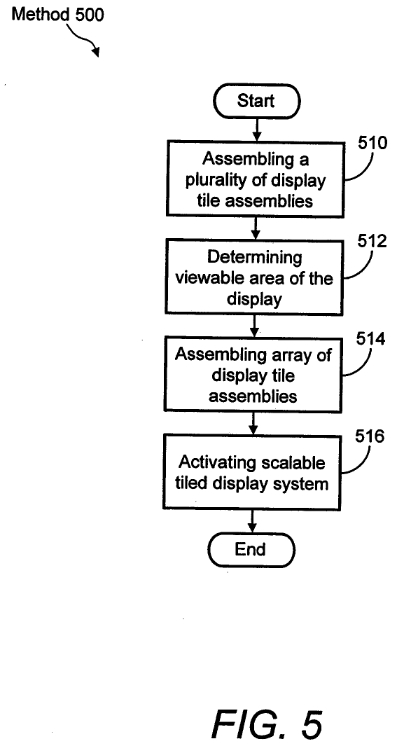

FIG. 5 illustrates a flow diagram of a method 500 of forming a scalable tiled display system 400 in accordance with the invention.

At step 510, a plurality of display tile assemblies 200 are formed by a flat-panel display manufacturer for use within a scalable tiled display system 400. At step 512, the flat-panel display manufacturer (or display system customer) determines the size of the viewable area of the display scalable tiled display system 400 and, thus, determines the required configuration of the array of display tile assemblies 200. At step 514, the flat-panel display manufacturer assembles the plurality of display tile assemblies 200 edge-to-edge, according to the configuration determined at step 512. The flat-panel display manufacturer also connects all ribbon cables 310 between all driver sub-modules 214 and their respective display tiles 100 and connects cable 412 between all driver sub-modules 214 and central control module 410, accordingly. At step 516, the user activates scalable tiled display system 400 via central control module 410, which supplies image data that is specific to each display tile 100, based upon the physical location of each given display tile 100 within the overall scalable tiled display system 400 and, thus, each display tile 100 is independently addressed. Method 500 ends.

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed as new and desired to be protected by Letters Patent of the United States is:

1. A tiled display structure, comprising a plurality of display tiles arranged in an array, at least one of the plurality of display tiles having a first edge including a column driver region and a second edge including a row driver region, wherein the plurality of display tiles are arranged so that at least one of the first and second edges of the at least one of the plurality of display tiles is overlapped by an edge of another of the plurality of display tiles.

2. The tiled display structure of claim 1, wherein both of the first and second edges of the at least one of the plurality of display tiles are overlapped by edges of other display tiles of the plurality of display tiles.

3. The tiled display structure of claim 1, wherein the display tiles comprise organic light-emitting diode (OLED) devices.

4. The tiled display structure of claim 1, wherein the display tiles are arranged on a display tile frame.

5. The tiled display structure of claim 4, wherein the tile frame comprises at least one via for providing electrical circuitry to the first and second edges.

6. The tiled display structure of claim 5, wherein the electrical circuitry provides electrical connection between the column driver region and the row driver region and a driver sub-module corresponding to the at least one of the plurality of display tiles.

7. The tiled display structure of claim 6, wherein the driver sub-module is located within the display tile frame.

8. The tiled display structure of claim 1, wherein the tiled display structure has a thickness of about 6 to 10 millimeters.

9. An electronic display assembly, comprising:
an array of independently addressable display tiles, wherein each of the independently addressable display tiles comprises:
a display region defining a pixel area having an active region which occupies a portion of the pixel area; and
at least one active edge region adjacent the active region and including at least one of a column driver region and a row driver region,
wherein the independently addressable display tiles are arranged in the array so that the at least one active edge region of one independently addressable display tile overlaps with another edge of another display tile of the array.

10. The electronic display assembly of claim 9, wherein both the column driver region and the row driver region are provided on the at least one active edge region.

11. The electronic display assembly of claim 9, wherein only one of the column driver region and the row driver region is provided on the at least one active edge region.

12. The electronic display assembly of claim 11, wherein the other one of the column driver region and the row driver region is provided on another active edge region of the display tile, the another active edge region being adjacent the at least one active edge region.

13. The electronic display assembly of claim 9, wherein the active region includes at least one light-emitting device.

14. The electronic display assembly of claim 13, wherein the at least one light-emitting device is an organic light-emitting diode.

15. The electronic display assembly of claim 9, wherein each of the column driver region and the row driver region further comprises at least one driver and at least one electrode for driving the active region of each display tile.

16. The electronic display assembly of claim 9, wherein the display region is coupled to the upper surface of the substrate by a plurality of cable structures, the cable structures connecting the active region of each display tile to a corresponding driver sub-module.

17. The electronic display assembly of claim 16, wherein the plurality of cable structures comprises at least one flat ribbon cable.

18. A method of constructing a tiled electronic display structure, comprising:
assembling a plurality of independently addressable display tiles in an array, each of the display tiles having a display region defining a pixel area having an active region which occupies a portion of the pixel area, and at least one active edge region adjacent the active region and having integrated at least one of a column driver region and a row driver region,
wherein the step of assembling the plurality of independently addressable display tiles further comprises arranging the independently addressable display tiles so that the at least one active edge region of one independently addressable display tile overlaps with another edge of another independently addressable display tile of the array.

19. The method of claim 18, further comprising the steps of:
determining a desired viewable area for the electronic display structure; and
accordingly assembling a predetermined number of said plurality of independently addressable display tiles in the array, the number of said display tiles corresponding to the desired viewable area of the electronic display structure.
